(19) United States
(12) Patent Application Publication
(10) Pub. No.: US 2013/0210381 A1
(43) Pub. Date: Aug. 15, 2013

(54) APPARATUS AND ACCOUNT MANAGEMENT METHOD OF COMMUNICATION DEVICE

(71) Applicant: ZHONG-LIN XU, Shenzhen City (CN)

(72) Inventor: ZHONG-LIN XU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/532,851

(22) Filed: Jun. 26, 2012

(30) Foreign Application Priority Data
Feb. 15, 2012 (CN) 201210033588.1

(51) Int. Cl. H04W 4/24

(52) U.S. Cl. 455/406

(57) ABSTRACT

A computerized method manages prepaid fees of a communication device having a first prepaid account. The first prepaid account is bound with one or more second prepaid accounts of one or more third-party terminals. Residual prepaid fees of the first prepaid account, and whether the prepaid fees of the first prepaid account are less than a predetermined value is determined. When the residual prepaid fees of the first prepaid account are less than the predetermined value, one of the second prepaid accounts is determined as a fee transferring account. A request message is sent to a communication server to request transferring a predetermined amount of prepaid fees from the fee transferring account to the first prepaid account of the communication device.

### BACKGROUND

1. Technical Field

Embodiments of the present disclosure relate to an account management method of a communication device. 2. Description of Related Art

With the popularity of mobile communications, there are many telecommunication companies providing specialize services for users of communication devices. The users of the communication devices may have credit or debit accounts with the telecommunication company whereby fees are deducted from the accounts as the users utilize the services. However, users not monitoring their account regularly may have their service interrupted in the middle of an important transaction due to lack of funds. Therefore, an improved solution for managing these so-called prepaid fees of the communication device is desired.

### BRIEF DESCRIPTION OF THE DRAWINGS

FIG. 1 is a schematic block diagram illustrating one embodiment of one embodiment of a communication system including a communication server, a communication device and one or more third-party terminals.

FIG. 2 is a schematic block diagram illustrating one embodiment of functional modules of the communication device of FIG. 1.

FIG. 3 is a flowchart of one embodiment showing an account management method of the communication device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

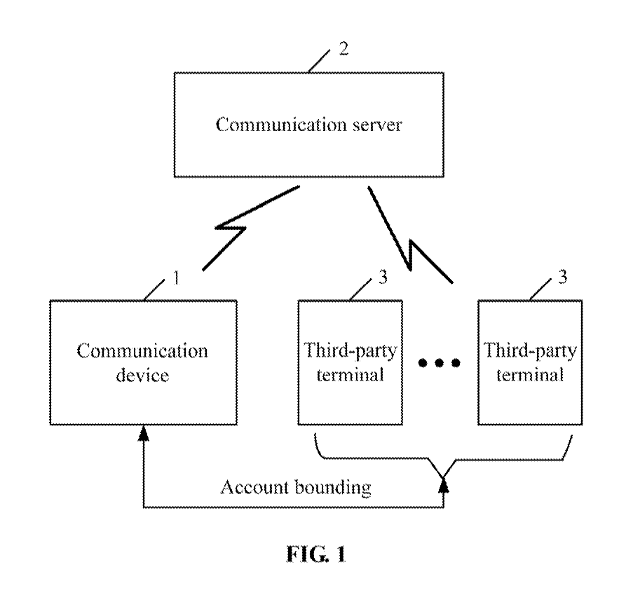

FIG. 1 is a schematic block diagram illustrating one embodiment of a communication system including a communication server 2, a communication device 1 and one or more third-party terminals 3. In the embodiment, the communication server 2 provides communication services for the communication device 1 and one or more third-party terminals 3. The communication server 2 may for example be provided by a telecommunication company, such as American Telephone & Telegraph (AT&T) Company or China Mobile Company (CMC). Both the communication device 1 and each of the third-party terminals 3 may be any kind of communication device, such as a smart phone, a personal digital assistant, a fixed telephone, or other similar device. The communication device 1 and the third-party terminals 3 can use the services provided by the communication server 2 to communicate with each other. The communication device 1 and each of the third-party terminals 3 have a prepaid account with the telecommunication company whereby prepaid fees are deducted from the accounts as the communication services are utilized. The prepaid account of the communication device 1 (hereinafter “first prepaid account”) is bound with the prepaid accounts of the third-party terminals (hereinafter “second prepaid accounts”) according to a predetermined contract, so that the communication device 1 and the third-party terminals 3 can share their prepaid fees according to the predetermined contract. The predetermined contract may be customized by the telecommunication company and stored in the communication server 2.

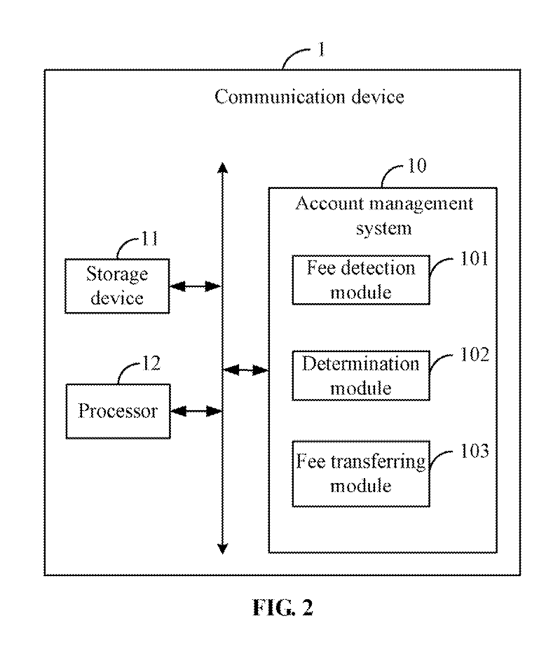

FIG. 2 is a schematic block diagram illustrating one embodiment of the communication device 1 of FIG. 1. The communication device 1 includes an account management system 10, a storage device 11, and a processor 12. The account management system 10 is executed by the processor 12 for managing prepaid fees of the communication device 1. The account management system 10 may include a plurality of programs in the form of one or more computerized instructions stored in the storage device 11 and executed by the processor 12 to perform operations of the communication device 1. In the embodiment, the account management system 10 includes a fee detection module 101, a determination module 102, and a fee transferring module 103. FIG. 2 is one example of the communication device 1, and the communication device 1 can include more or fewer components than those shown in the embodiment, or have a different configuration of the components.

In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The fee detection module 101 detects residual prepaid fees of the first prepaid account of the communication device 1, and determines whether the prepaid fees of the first prepaid account are less than a predetermined value. In this embodiment, the detecting of the residual prepaid fees of the first prepaid account may be automatically activated at regular intervals, such as every one or two minutes, after a communication (e.g., a voice communication) is established by the communication device 1. In other embodiments, the detecting of the residual prepaid fees of the first prepaid account may be manually activated at any time according to requirements of the user. The residual prepaid fees of the communication device 1 can be detected from the communication server 2 by sending a first predetermined command to the communication server 2.

The determination module 102 determines one of the second prepaid accounts as a fee transferring account when the residual prepaid fees of the first prepaid account are less than the predetermined value. In the embodiment, the determination module 102 inquires residual prepaid fees of each of the second prepaid accounts of the one or more third-party terminals 3 from the communication server 2, and determines one of the second prepaid accounts, which has the most residual prepaid fees as the fee transferring account. The residual prepaid fees of each of the second prepaid accounts of the one or more third-party terminals 3 are inquired from the communication server 2 by sending a second predetermined command to the communication server 2. In another embodiment, the fee transferring account may be determined according to a predetermined priority of the second accounts. For example, one of the second accounts which has a higher priority and has more than a preset amount of residual prepaid fees may be determined as the fee transferring account. In addition, the fee detection module 101 may alert a user of the communication device 1 by triggering the communication device 1 to output voices or vibrations when the residual prepaid fees of the communication device 1 are less than the predetermined value.

The fee transferring module 103 sends a request message to the communication server 2, to request transferring a predetermined amount of prepaid fees from the determined fee transferring account to the first prepaid account of the communication device 1. The request message may be a text message or a short message that includes information indicating the determined fee transferring account and/or the predetermined amount of prepaid fees. The predetermined amount of prepaid fees may be presented in the predetermined contract. When the request message is received by the communication server 2, the communication server 2 automatically transfers the predetermined amount of prepaid fees from the fee transferring account to the first prepaid account of the communication device 1 according to the predetermined contract.

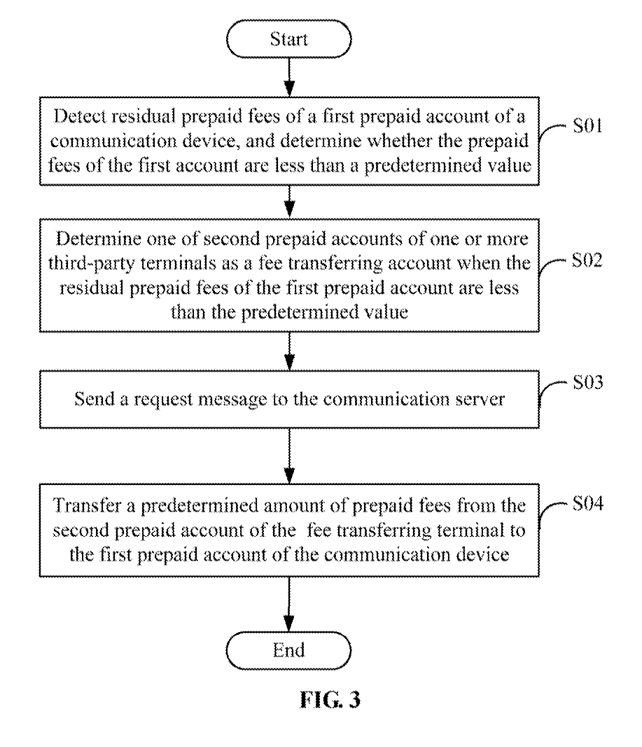

FIG. 3 shows a flowchart of one embodiment of an account management method of the communication device 1 of FIG. 1. Depending on the embodiment, additional steps may be added, others removed, and the ordering of the steps may be changed.

In step S01, the fee detection module 101 detects residual prepaid fees of the first prepaid account of communication device 1, and determines whether the prepaid fees of the first prepaid account are less than a predetermined value. In this embodiment, the detecting of the residual prepaid fees of the communication device 1 may be automatically activated or manually activated as described above.

In step S02, when the residual prepaid fees of the first prepaid account are less than the predetermined value, the determination module 102 determines one of the second prepaid accounts of the third-party terminals 3 as a fee transferring account. The determination of the fee transferring account is provided above. In addition, the fee detection module 101 may alert a user of the communication device 1 by triggering the communication device 1 to output voices or vibrations, when the residual prepaid fees of the communication device 1 are less than the predetermined value.

In step S03, the fee transferring module 103 sends a request message to the communication server 2.

In step S04, the communication server 2 transfers a predetermined amount of prepaid fees from the determined fee transferring account to the first prepaid account of the communication device 1 according to the predetermined contract.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized account management method of a communication device having a first prepaid account, the first prepaid account being bound with one or more second prepaid accounts of one or more third-party terminals, the method comprising:
detecting residual prepaid fees of the first prepaid account of the communication device, and determining whether the prepaid fees of the first prepaid account are less than a predetermined value;
determining one of the second prepaid account as a fee transferring account when the residual prepaid fees of the first prepaid account are less than the predetermined value; and
sending a request message to a communication server to request transferring a predetermined amount of prepaid fees from the determined fee transferring account to the first prepaid account of the communication device, wherein the communication server provides communication services for the communication device and the third-party terminals.

2. The method according to claim 1, wherein the detecting step is automatically activated at regular intervals after a communication is established by the communication device.

3. The method according to claim 1, wherein the detecting step is manually activated according to user requirements.

4. The method according to claim 1, wherein the first prepaid account is bound with the second prepaid accounts of the one or more third-party terminals according to a predetermined contract, which is customized by a telecommunication company and stored in the communication server.

5. The method according to claim 4, wherein the communication server automatically transfers the predetermined amount of prepaid fees from the determined fee transferring account to the first prepaid account of the communication device according to the predetermined contract, when the request message is received.

6. The method according to claim 1, wherein the fee transferring account is determined by:
inquiring residual prepaid fees of each of the second prepaid accounts of the one or more third-party terminals from the communication server; and
determining one of the second prepaid accounts which has the most residual prepaid fees as the fee transferring account.

7. The method according to claim 1, wherein the fee transferring account is determined according to a predetermined priority of the second accounts, and one of the second accounts which has a higher priority and has more than a preset amount of residual prepaid fees is determined as the fee transferring account.

8. The method according to claim 1, further comprising:
alerting a user of the communication device by triggering the communication device to output voices or vibrations, when the residual prepaid fees of the communication device are less than the predetermined value.

9. A communication device having a first prepaid account for storing prepaid fees, the first prepaid account being bound with one or more second prepaid accounts of one or more third-party terminals, the communication device comprising:
a storage device;
a processor;
one or more programs stored in the storage device and executed by the processor, the one or more programs comprising:
a fee detection module that detects residual prepaid fees of the first prepaid account of the communication device, and determines whether the prepaid fees of the first prepaid account are less than a predetermined value;
a determination module that determines one of the second prepaid accounts of the one or more third-party terminals as a fee transferring account when the residual prepaid fees of the first prepaid account are less than the predetermined value; and
a fee transferring module that sends a request message to a communication server to request transferring a predetermined amount of prepaid fees from the determined fee transferring accounts to the first prepaid account of the communication device.

10. The communication device according to claim 9, wherein the fee detection module is automatically activated at regular intervals after a communication is established by the communication device.

11. The communication device according to claim 9, wherein the fee detection module is manually activated according to user requirements.

12. The communication device according to claim 9, wherein the first prepaid account is bound with the second prepaid accounts of the one or more third-party terminals according to a predetermined contract, which is customized by a telecommunication company and stored in the communication server.

13. The communication device according to claim 12, wherein the communication server automatically transfers the predetermined amount of prepaid fees from the determined fee transferring account to the first prepaid account of the communication device according to the predetermined contract, when the request message is received.

14. The communication device according to claim 9, wherein the determination module inquires residual prepaid fees of each of the second prepaid accounts of the one or more third-party terminals from the communication server, and determines one of the second prepaid accounts which has the most residual prepaid fees as the fee transferring account.

15. The communication device according to claim 9, wherein the fee transferring account is determined according to a predetermined priority of the second accounts, and the determination module determines one of the second accounts which has a higher priority and has more than a preset amount of residual prepaid fees as the fee transferring account.

16. The communication device according to claim 9, wherein the fee detection module further alerts a user of the communication device by triggering the communication device to output voices or vibrations, when the residual prepaid fees of the communication device are less than the predetermined value.
